(19) United States
(12) Patent Application Publication
(10) Pub. No.: US 2009/0236038 A1
(43) Pub. Date: Sep. 24, 2009

(54) Method for manufacturing insulating sheet and method for manufacturing metal clad laminate and printed circuit board using the same

(75) Inventors: Nobuyuki Ikeguchi, Suwon-si (KR); Keungjin Sohn, Seongnam-si (KR); Joon-Sik Shin, Suwon-si (KR); Joung-Gul Ryu, Seoul (KR); Jung-Hwan Park, Seongnam-si (KR); Ho-Sik Park, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 12/222,966

(22) Filed: Aug. 20, 2008

(30) Foreign Application Priority Data
Mar. 18, 2008 (KR) 10-2008-0024808

(51) Int. Cl. B32B 37/06; B32B 37/04; B32B 37/16

(52) U.S. Cl. 156/280; 156/309.6; 156/289

(57) ABSTRACT

A method for manufacturing an insulating sheet, a method for manufacturing a metal clad laminate, and a method for manufacturing a printed circuit board are disclosed. The method for manufacturing an insulating sheet may include stacking a thermoplastic resin layer over a reinforcement material, and hot pressing the thermoplastic resin layer into the reinforcement material to impregnate and attach the thermoplastic resin layer into the reinforcement material. Certain embodiments of the invention can be utilized to produce an insulation board that has a coefficient of thermal expansion close to that of the semiconductor chip, and thereby prevent bending or warpage in the multi-layer printed circuit board using the insulation board. Furthermore, the stress in the material connecting the semiconductor chip with the printed circuit board can be reduced, so that cracking or delamination in the connecting material, such as lead-free solder, may be avoided.

### CROSS-REFERENCE TO RELATED APPLICATIONS

This application claims the benefit of Korean Patent Application No. 10-2008-0024808 filed with the Korean Intellectual Property Office on Mar. 18, 2008, the disclosure of which is incorporated herein by reference in its entirety.

### BACKGROUND

1. Technical Field

The present invention relates to a method for manufacturing an insulating sheet, a method for manufacturing a metal clad laminate, and a method for manufacturing a printed circuit board.

2. Description of the Related Art

Current electronic devices are trending towards smaller, thinner, and lighter products. In step with these trends, the preferred methods for mounting semiconductor chips are changing from wire bonding methods to flip chip methods, which allow greater numbers of terminals. Furthermore, there is a demand also for higher reliability and higher densities in the multi-layer printed circuit board, to which semiconductor chips may be mounted.

In the conventional multi-layer printed circuit board, if fiberglass woven fabric is used for the base material, E-glass fiber, etc., is generally used for the fiberglass component.

A thermosetting resin composition may be impregnated into the fiberglass woven fabric, dried, and put in a B-stage condition, which can then be processed into a copper clad laminate. This copper clad laminate can be used to fabricate a printed circuit board core, for use in the inner layers, after which B-stage thermosetting resin insulation sheets may be arranged and stacked as build-up layers to manufacture a multi-layer printed circuit board.

In the multi-layer printed circuit board, a build-up resin composition may be used in many of the layers, which has a high coefficient of thermal expansion (CTE) (generally about 18 to 100 ppm/° C. in the longitudinal and lateral directions), and a copper (Cu) layer having a coefficient of thermal expansion of about 17 ppm/° C. may be included in each layer. On the outermost layers, solder resist layers may be formed which also have a high rate of thermal expansion (generally about 50 to 150 ppm/° C.). Consequently, the overall coefficient of thermal expansion in the longitudinal and lateral directions for the multi-layer printed circuit board may be about 13 to 30 ppm/° C.

Even in cases where a multi-layer printed circuit board is formed with a resin having high thermal resistance used for the thermosetting resin, or with an inorganic filler added to the resin, or with a fiberglass woven fabric having a low coefficient of thermal expansion used as a reinforcement material, the overall coefficient of thermal expansion may remain at about 10 to 20 ppm/° C.

The coefficient of thermal expansion of the multi-layer printed circuit board manufactured as above may be much greater than the coefficient of thermal expansion of the semiconductor chip, which is generally about 2 to 3 ppm/° C. With current environmental problems urging the use of lead-free solder in flip chip bonding, this difference can lead to defects, such as cracking and delamination in the lead-free solder and damage in the semiconductor chip, etc., as the multi-layer printed circuit board expands and contracts in the longitudinal and lateral directions during reliability tests such as temperature cycle tests, etc.

Moreover, in a semiconductor plastic package that has semiconductor chips mounted on one side, the large difference in coefficients of thermal expansion between the semiconductor chips and the multi-layer printed circuit board can lead to significant bending or warpage during the reflowing process.

In an effort to alleviate the stresses generated when a semiconductor chip is mounted on the multi-layer printed circuit board, a method has been proposed (e.g. Japanese Patent Publication No. 2001-274556) of forming organic insulation layers that have a low coefficient of thermal expansion in the outermost layers of the multi-layer printed circuit board, which has a coefficient of thermal expansion of about 13 to 20 ppm/° C.

The above publication specifically discloses a multi-layer printed circuit board that uses for the organic insulation layer a prepreg made by impregnating a thermosetting resin into a reinforcement material of aramid fiber woven fabric, which has a coefficient of thermal expansion of about 9 ppm/° C. The publication, however, does not provide detailed reliability test results. Also, when a thermally alleviating organic insulation sheet, of 6 to 12 ppm/° C., is attached in an integrated manner according to the disclosure of the above publication, the high coefficient of thermal expansion of the integrated multi-layer printed circuit board may lead to the thermally alleviating organic insulation sheet being pulled and stretched, resulting in the overall coefficient of thermal expansion of the integrated multi-layer printed circuit board exceeding 10 ppm/° C.

When a reliability test, such as a temperature cycle test, etc., is performed for this integrated multi-layer printed circuit board with semiconductor chips mounted using lead-free solder, it may be shown that the organic insulation sheet intended to serve as a thermal buffer may be largely ineffective, because the difference in the rate of thermal expansion between the semiconductor chips and the integrated multi-layer printed circuit boards may cause defects such as cracking and delamination in the lead-free solder connecting the semiconductor chips.

### SUMMARY

An aspect of the invention is to provide a method for manufacturing an insulating sheet, and a method for manufacturing a metal clad laminate and a method for manufacturing a printed circuit board using the method for manufacturing an insulating sheet, which can prevent the semiconductor chips and lead-free solder, etc., from being damaged or delaminated, and which can prevent bending or warpage in a multi-layer printed circuit board.

One aspect of the invention provides a method for manufacturing an insulating sheet. The method may include stacking a thermoplastic resin layer over a reinforcement material, and hot pressing the thermoplastic resin layer into the reinforcement material to impregnate and attach the thermoplastic resin layer into the reinforcement material.

Here, the coefficient of thermal expansion of the reinforcement material can be within a range of −20 to 9 ppm/° C. in the longitudinal and lateral directions. The reinforcement material can be made of organic fibers.

The organic fibers may be made from any one of aromatic polyamide and polybenzoxazole.

Also, the coefficient of thermal expansion of the thermoplastic resin layer can be within a range of −20 to 9 ppm/° C. in the longitudinal and lateral directions. The thermoplastic resin layer can include a liquid crystal polyester resin.

The fusion point of the reinforcement material may be higher than that of a thermoplastic resin layer stacked on at least one side of the reinforcement material.

The hot pressing operation can be performed with a pressure of 1 to 50 kgf/cm² at a temperature 10 to 50° C. higher than the fusion point of the thermoplastic resin layer, to impregnate and attach the thermoplastic resin layer into the reinforcement material. Before the hot pressing, the method may further include stacking a detachable sheet over at least one side of the thermoplastic resin layer.

Another aspect of the invention provides a method for manufacturing a metal clad laminate. The method may include stacking a thermoplastic resin layer over a reinforcement material, hot pressing the thermoplastic resin layer into the reinforcement material to impregnate or attach the thermoplastic resin layer into the reinforcement material, and forming a metal layer over the thermoplastic resin layer.

Here, the coefficient of thermal expansion of the reinforcement material can be within a range of −20 to 9 ppm/° C. in the longitudinal and lateral directions. The reinforcement material can be made of organic fibers.

The organic fibers may be made from any one of aromatic polyamide and polybenzoxazole.

Also, the coefficient of thermal expansion of the thermoplastic resin layer can be within a range of −20 to 9 ppm/° C. in the longitudinal and lateral directions. The thermoplastic resin layer can include a liquid crystal polyester resin.

The fusion point of the reinforcement material may be higher than that of a thermoplastic resin layer stacked on at least one side of the reinforcement material.

The hot pressing operation can be performed with a pressure of 1 to 50 kgf/cm² at a temperature 10 to 50° C. higher than the fusion point of the thermoplastic resin layer, to impregnate and attach the thermoplastic resin layer into the reinforcement material.

Yet another aspect of the invention provides a method for manufacturing a printed circuit board. The method may include stacking a thermoplastic resin layer over a reinforcement material, hot pressing the thermoplastic resin layer into the reinforcement material to impregnate or attach the thermoplastic resin layer into the reinforcement material, forming a metal layer over the thermoplastic resin layer, and forming a circuit pattern by etching the metal layer.

Here, the coefficient of thermal expansion of the reinforcement material can be within a range of −20 to 9 ppm/° C. in the longitudinal and lateral directions. The reinforcement material can be made of organic fibers.

The organic fibers may be made from any one of aromatic polyamide and polybenzoxazole.

Also, the coefficient of thermal expansion of the thermoplastic resin layer can be within a range of −20 to 9 ppm/° C. in the longitudinal and lateral directions. The thermoplastic resin layer can include a liquid crystal polyester resin.

The fusion point of the reinforcement material may be higher than that of a thermoplastic resin layer stacked on at least one side of the reinforcement material.

The hot pressing operation can be performed with a pressure of 1 to 50 kgf/cm² at a temperature 10 to 50° C. higher than the fusion point of the thermoplastic resin layer, to impregnate and attach the thermoplastic resin layer into the reinforcement material.

Additional aspects and advantages of the present invention will be set forth in part in the description which follows,-and in part will be obvious from the description, or may be learned by practice of the invention.

### BRIEF DESCRIPTION OF THE DRAWINGS

FIG. 1 is a flowchart illustrating a method of manufacturing a printed circuit board according to an embodiment of the invention.

FIG. 2 and FIG. 3 are cross sectional views representing a flow diagram for a method of manufacturing an insulating sheet according to an embodiment of the invention.

FIG. 4, FIG. 5, FIG. 6, FIG. 7, FIG. 8, and FIG. 9 are cross sectional views representing a flow diagram for a method of manufacturing a multi-layer printed circuit board using metal clad laminates according to an embodiment of the invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Certain embodiments of the invention will be described below in more detail with reference to the accompanying drawings.

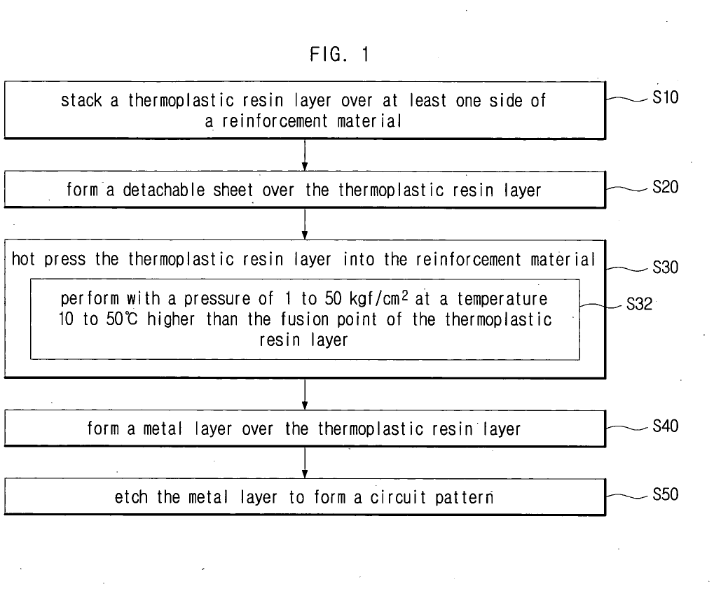

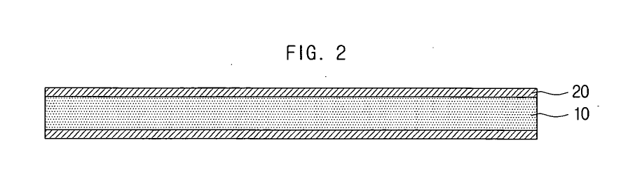

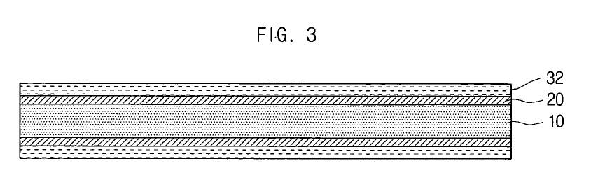

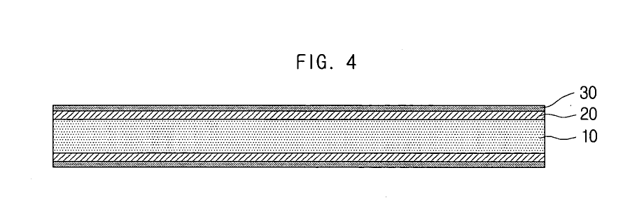

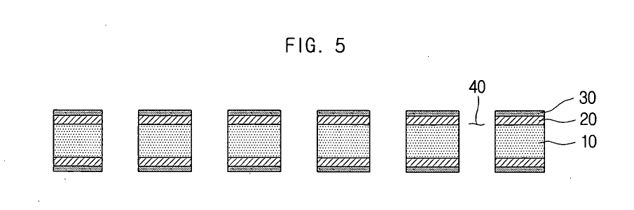

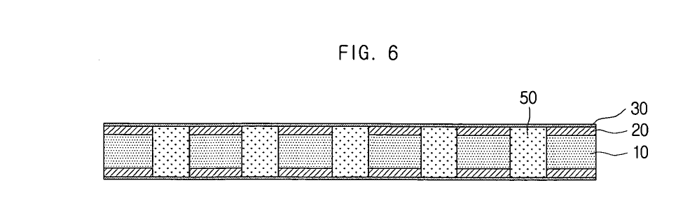

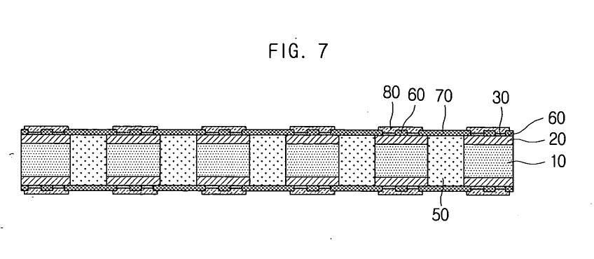

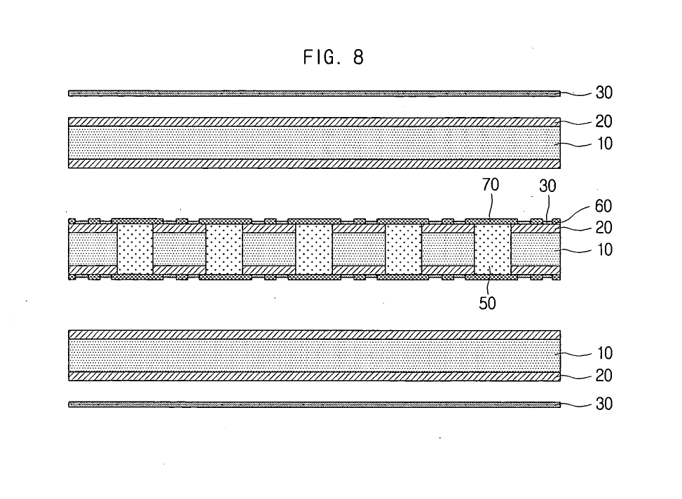

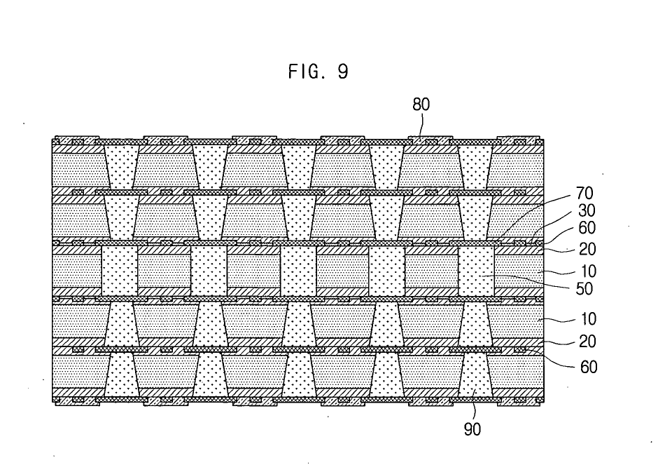

FIG. 1 is a flowchart illustrating a method of manufacturing a printed circuit board according to an embodiment of the invention, FIG. 2 and FIG. 3 are cross sectional views representing a flow diagram for a method of manufacturing an insulating sheet according to an embodiment of the invention, and FIG. 4 through FIG. 9 are cross sectional views representing a flow diagram for a method of manufacturing a multi-layer printed circuit board using metal clad laminates according to an embodiment of the invention.

In FIG. 2 to FIG. 9, there are illustrated reinforcement materials 10, thermoplastic resin layers 20, detachable sheets 32, metal layers 30, through-holes 40, vias 50, 90, circuit patterns 60, lands 70, and solder resists 80.

A method for manufacturing an insulating sheet according to this embodiment can include stacking a thermoplastic resin layer over at least one side of a reinforcement material and impregnating and attaching the thermoplastic resin layer into the reinforcement material by hot pressing. This embodiment will be described using an example in which a thermoplastic resin layer is stacked over either side of a reinforcement material.

First, a thermoplastic resin layer 20 can be stacked over at least one side of a reinforcement material 10 (S10). In this particular embodiment, thermoplastic resin layers 20 can be stacked over both sides of the reinforcement material 10, as illustrated in FIG. 2. The method of manufacturing a printed circuit board according to this embodiment will be described using an example in which liquid polyester resin is used for the thermoplastic resin layers 20.

Here, the coefficient of thermal expansion of the reinforcement material 10 in the longitudinal and lateral directions can be within a range of −20 to 9 ppm/° C., and the reinforcement material 10 can be made of organic fibers. For example, the reinforcement material 10 can be made from one of aromatic polyamide and polybenzoxazole.

For example, woven or non-woven fabric of organic fibers such as aromatic polyamide fibers, polybenzoxazole fibers, and liquid crystal polyester fibers, which have a low coefficient of thermal expansion of 9 ppm/° C. or lower in the longitudinal and lateral directions, can be used as the reinforcement material 10.

The polybenzoxazole can include, for example, polyimide benzoxazole, poly-paraphenylene benzobisoxazole, etc. The aromatic polyamide can include, for example, poly-metaphenylene isophthalamide, co-poly-(paraphenylene/3,4′-oxydiphenylene terephthalamide), etc.

Here, at the maximum temperature reached when mounting components onto a printed circuit board, which is about 260° C., the aromatic polyamide fibers or polybenzoxazole fibers may not melt and thus may not pose a problem. However, certain liquid crystal polyester fibers may have a fusion point close to 260° C., and if these fibers are used as the reinforcement material 10, the reinforcement material may be fused at the mounting temperature, whereby the reinforcing effect may be degraded. Therefore, it can be advantageous to use a reinforcement material 10 that has a fusion point higher by 10° C. or more than the fusion point of the liquid crystal polyester resin layers 20 stacked over the reinforcement material 10.

Furthermore, a low CTE material having a coefficient of thermal expansion of 9 ppm/° C. or lower in the longitudinal and lateral directions, such as a polyimide film, an aromatic polyamide film, a polybenzoxazole film, and a liquid crystal polyester film having a fusion point higher than that of the liquid crystal polyester resin layers 20 stacked on, can be used for the reinforcement material 10.

In order to improve the adhesion between the reinforcement material 10 and the resin layers, a known surface treatment can be applied to the reinforcement material 10, examples of which include applying a silane coupling agent, plasma treatment, corona treatment, various chemical treatment, and blast treatment, etc.

The reinforcement material 10 is not limited to a particular thickness. However, a thickness between 4 and 200 μm, and in certain cases between 10 and 150 μm, can be advantageous.

The coefficient of thermal expansion of the thermoplastic resin layers 20 in the longitudinal and lateral directions can be within a range of −20 to 9 ppm/° C. In describing this particular embodiment, liquid crystal polyester resin will be used as an example of a thermoplastic resin layer 20. The thermoplastic resin layers 20 can be selected such that the fusion point of the reinforcement material 10 is higher than the fusion point of the thermoplastic resin layers 20.

While the coefficient of thermal expansion of the liquid crystal polyester resin layers 20 is not limited to a particular value, in certain examples the coefficient of thermal expansion can be 9 ppm/° C. or lower at −60 to 200° C. In consideration of environmental problems, it can be advantageous not to include halogen elements in the molecules. The molecular structure is not limited to a particular type, and the molecular structure can be designed such that the coefficient of thermal expansion is 9 ppm/° C. or lower. The resin can be used dissolved in a solvent or in a sheet.

Adequate amounts of various additives can be added to the resin, to such a degree that the desired properties of the resin remain unaltered. For example, any of various thermosetting resins, thermoplastic resins, or other resins, and any of various known additives such as organic/inorganic fillers, dyes, pigments, thickening agents, antifoaming agents, dispersing agents, brightening agents, etc., can be added to form the liquid crystal polyester resin layers 20.

The thickness of the liquid crystal polyester resin layer 20 from the reinforcement material 10 is not limited to a particular value, but may generally be between 5 to 100 μm. In addition, the total thickness of the insulating sheet, including the reinforcement material 10, is not limited to a particular value, but may generally be 10 to 500 μm, or in some cases 20 to 150 μm.

The manufacturing of the insulating sheet by attaching the liquid crystal polyester resin layers 20 onto the reinforcement material 10 is not limited to a particular method. In certain examples, a liquid crystal polyester resin can be dissolved in an organic solvent (such as N-methyl-2-pyrrolidone, etc.), to which adequate amounts of suitable additives can be added and evenly dispersed. Using a process of continuously precipitating and drying this dispersed varnish solution and evaporating the solvent, the liquid crystal polyester resin 20 can be impregnated into the reinforcement material, to manufacture an insulating sheet for a printed circuit board.

Next, as illustrated in FIG. 3, a detachable sheet 32 can be formed over the thermoplastic resin layer 20 (S20), and the thermoplastic resin layer 20 can be hot pressed into the reinforcement material 10 (S30). The hot pressing can be applied at a temperature 10 to 50° C. higher than the fusion point of the thermoplastic resin layer 20 with a pressure of 1 to 50 kgf/cm² (S32).

When an organic film is used for the reinforcement material 10, a varnish of the liquid crystal polyester resin can be coated continuously, using a roller, etc., over at least one side of the film, to which a surface treatment has been applied, after which the resin varnish can be dried and the solvent evaporated. The liquid crystal polyester resin layer 20 can be formed over one or either side of the organic film to manufacture the insulating sheet.

It is also possible to manufacture an insulating sheet and a metal clad laminate by positioning a film prepared beforehand by extrusion molding or casting, etc., on one or either side of the organic film, arranging a detachable film or a metal layer on the outer side, applying pressure and heat, and afterwards dissolving and attaching the liquid crystal polyester resin in a vacuum environment.

It can be advantageous to have the liquid crystal polyester resin dissolved and impregnated in the reinforcement material 10, even in cases where the liquid crystal polyester resin layer 20 is attached to the reinforcement material 10 film.

Next, as illustrated in FIG. 4, after hot pressing the thermoplastic resin layers 20 into the reinforcement material 10, a metal layer 30 can be formed over the thermoplastic resin layer 20 (S40).

The metal layer 30 attached thus to one or either side of an organic fiber reinforcement material 10 for use in a printed circuit board is not limited to a particular metal, and various known metals, such as copper, iron, nickel, magnesium, cobalt, tungsten, titanium, aluminum, etc., or an alloy of such metals can be used.

In cases where the main purpose of the printed circuit board is to allow high-frequency uses, rather than to provide a low coefficient of thermal expansion, a typical electroplated copper foil or a rolled copper foil can be used for the metal layer 30. In cases where the main purpose is to provide a printed circuit board having a coefficient of thermal expansion of 9 ppm/° C. or lower, a multi-layer metal can be used, such as copper/invar/copper. That is, a nickel-iron type or nickel-iron-cobalt type alloy can be attached together with layers of copper over at least one side.

If the organic fiber reinforcement material used has a sufficiently low coefficient of thermal expansion, a printed circuit board having a coefficient of thermal expansion of 9 ppm/° C. or lower may still be obtained after applying the copper foil. A degree of roughness can be provided on the surface of the metal layer that is to be attached to the resin composition, or a certain other type of surface treatment can be applied. A treatment method known to those skilled in the art can be used for the surface treatment. For example, if a multi-layer metal (e.g. copper/invar/copper, etc.) is used, a known method such as a black oxide treatment, brown oxide treatment, and a chemical treatment, etc., can be applied to the surface of the copper layer.

In this particular embodiment, the metal layer 30 can be arranged over at least one side of an organic fiber reinforcement material 10 for use in a printed circuit board. In cases where the reinforcement material 10 is an aromatic polyamide fabric or film, or a polybenzoxazole fabric or film, if the fusion point of the attached liquid crystal polyester resin composition is between 200 to 300° C., the layers may be stacked and molded in a vacuum environment at a temperature higher than the fusion point by about 10 to 50° C.

Of course, it is also possible to perform the stacking at a temperature higher than the fusion point of the liquid crystal polyester resin by more than 50° C., but if the stacking temperature is too high, the viscosity of the fused resin may be excessively lowered, so that the resin may flow over the sides, and the metal clad laminate may be manufactured with an uneven thickness.

Especially in cases where an inorganic filler, etc., is included in the resin layer, a stacking temperature close to the fusion point may cause voids in the resin layers after the stacking and thus may not be desired. In the case of a single-sided metal clad laminate, a detachable film, such as a fluorine resin film, etc., can be applied over the surface of the resin where the metal layer is not attached, to allow detaching after the stacking and molding.

In forming a printed circuit board, it is also possible to use a prepreg, obtained by impregnating a resin composition other than a liquid crystal polyester resin composition, into an organic reinforcement material, inorganic reinforcement material, or an organic/inorganic mixed reinforcement material, in combination with a B-stage sheet. Of course, layers of liquid crystal polyester film can also be included in the combination. However, it can be advantageous to keep the coefficient of thermal expansion of the printed circuit board at or below 9 ppm/° C.

The prepreg and B-stage sheets used in a printed circuit board of this embodiment can be such that are known to those skilled in the art. One or more types of thermosetting resins, thermoplastic resins, UV-curable resins, and unsaturated-group-containing resins may generally be used that are known to those skilled in the art. The thermosetting resin can be of any type known to those skilled in the art, For example, epoxy resin, cyanate ester resin, bismaleimide resin, polyimide resin, functional-group-containing polyphenylene ether resin, cardo resin, benzocyclobutene resin, and phenol resin, etc., can be used alone or in a mixture of two or more resins.

A cyanate ester resin may be utilized to prevent migration between through-holes or circuits, which are being implemented in smaller and smaller pitches. Furthermore, types of resin known to those skilled in the art, some of which have been listed above, may be used after applying flame-retardant treatment with phosphorus or bromine. While a thermosetting resin according to this embodiment can be cured by heating the resin as is, this may entail a slow curing rate and low productivity. Thus, an adequate amount of curing agent or thermosetting catalyst may advantageously be used in the thermosetting resin.

Various other additives may generally be used in the thermosetting resin. For example, a thermosetting resin, a thermoplastic resin, or another type of resin may be added, other than the main resin used, as well as adequate amounts of an organic or inorganic filler, a dye, pigments, a thickening agent, lubricant, an antifoaming agent, a dispersing agent, leveling agent, brightening agent, and thixotropic agent, etc., according to the purpose and usage of the composition. It is also possible to use a flame retardant, such as those using phosphorus and bromine, and non-halogenated types.

A thermoplastic resin suitably used in the prepreg in this embodiment can be of any type known to those skilled in the art, including those other than the liquid crystal polyester resin used in the reinforcement material. Specific examples may include liquid crystal polyester resin, polyurethane resin, polyamide-imide resin, polyphenylene ether resin, etc. One or more of such resins may also be used in combination with a thermosetting resin. An adequate amount of various additives mentioned above may be added to the resin composition.

Besides the thermosetting resin and thermoplastic resin, other resins may be used alone or in combination, such as UV-curable resins and radical-curable resins, etc. Also, a photopolymerization initiator or radical polymerization initiator, for facilitating the relevant reactions, and/or the various additives described above can be mixed in adequate amounts.

In terms of the reliability of the printed circuit board according to an embodiment of the invention, it may be advantageous to utilize thermosetting resins and heat-resistant thermoplastic resins.

As described above, a printed circuit board manufactured with an organic fiber reinforcement material 10 according to this embodiment may use a combination of various materials in accordance with the purpose or the desired coefficient of thermal expansion of the printed circuit board.

For example, in the case of manufacturing a multi-layer printed circuit board for high-frequency uses, liquid crystal polyester resin layers can be arranged in layers for transferring such signals, while epoxy resin layers, cyanate ester resin layers, etc., can be arranged in other layers.

Also, in the case of manufacturing a multi-layer printed circuit board such that the overall coefficient of thermal expansion is 9 ppm/° C. or lower, a printed circuit board having a coefficient of thermal expansion of 9 ppm/° C. or lower may be used in the inner core, while organic fiber reinforcement materials 10 having a coefficient of thermal expansion of 9 ppm/° C. or lower may be used also in the build-up layers.

Next, as illustrated in FIG. 5, through-holes 40 can be formed in the insulating sheet stacked with a metal layer 30, and as illustrated in FIG. 6, vias 50 can be formed by plating the through-holes 40 or filling the through-holes 40 with a metal paste.

Next, as illustrated in FIG. 7, the metal layer 30 can be etched to form a circuit pattern 60 and lands 70 on which to mount a semiconductor chip (S50), where the circuit patterns 60 formed on both sides of the insulating sheet can be electrically connected by the vias 50, i.e. the through-holes filled with copper plating or with a metal paste. Solder resists 80 can also be coated on to protect the circuit patterns 60. Here, the vias 50, 90 may refer to via holes filled in with copper plating or with a metal paste.

The metal layer 30 and the solder resist layer 80 covering the circuit pattern 60 on the outermost layer may also each be made from a metal layer and a liquid crystal polyester film or organic fiber reinforcement material 10, etc., having a coefficient of thermal expansion of 9 ppm/° C. or lower. Examples of methods for forming the circuit patterns 60 of the multi-layer printed circuit board may include subtractive methods and semi-additive methods.

Next, as illustrated in FIG. 8, insulating sheets having organic fiber reinforcement materials 10 and thermoplastic resin layers 20 stacked together can be built-up over either side of the printed circuit board, and metal layers 30 may be arranged on the outermost layers. Afterwards, the configuration can be hot pressed to form a multi-layer printed circuit board, as illustrated in FIG. 9.

According to this embodiment, a multi-layer printed circuit board can be manufactured that has a coefficient of thermal expansion similar to that of a semiconductor chip. Thus, bending or warpage in the printed circuit board can be avoided, and excessive stresses in the connecting material between the semiconductor chip and the printed circuit board can be prevented, so that cracking or delamination in the connecting material, such as lead-free solder, etc., may not occur.

The coefficient of thermal expansion of an organic fiber reinforcement material 10 based on an embodiment of the invention may be 9 ppm/° C. or lower. In certain embodiments, the coefficient of thermal expansion may be −20 to 7 ppm/° C., and in some embodiments, −15 to 5.5 ppm/° C. Such materials can be used to manufacture a double-sided printed circuit board or a multi-layer printed circuit board.

Since the coefficient of thermal expansion of a semiconductor chip mounted on a printed circuit board is generally low, being about 2 to 3 ppm/° C., it can be advantageous to manufacture the printed circuit board such that its coefficient of thermal expansion is as close as possible to the coefficient of thermal expansion of the semiconductor, especially in the case of thin printed circuit boards.

A large difference in the coefficients of thermal expansion can lead to bending and warpage after the semiconductor chip is mounted and connected, and thus can result in a defect. A large difference in the coefficients of thermal expansion can also increase the likelihood of defects, such as cracking and delamination in the lead-free bumps for connecting the semiconductor chip and the printed circuit board, as well as damage in the semiconductor chip.

With an embodiment of the invention, however, a double-sided or a multi-layer printed circuit board can be manufactured that has a coefficient of thermal expansion close to that of the semiconductor chip, to prevent bending or warpage in the printed circuit board and prevent delamination or cracking in the connecting material or semiconductor chip. Also, since there is no need for an underfill resin in the connecting material between the printed circuit board and the semiconductor chip, it may be possible to rework a faulty component, for greater benefits in terms of cost.

A double-sided or multi-layer printed circuit board according to an embodiment of the invention can be a printed circuit board suited for mounting a semiconductor chip, but it is apparent that wire bonding may also be used. In such cases, instead of forming the pads at the lower portion of the semiconductor chip, the pads may be formed on the outermost layer for wire bonding connection. Of course, it is possible to connect a semiconductor chip in one or either side.

### MANUFACTURE EXAMPLE 1

### Liquid Crystal Polyester Resin for Use in Build-Up Layers

Layers of a 50 μm liquid crystal polyester film B (product code: FA film, fusion point: 281° C., CTE: −5.0 ppm/° C., Kuraray Co., Ltd.) were prepared.

### MANUFACTURE EXAMPLE 2

### Low CTE Organic Fiber Reinforcement Material

(1) Aromatic Polyamide Fabric

Layers of a 100 μm para-type polyamide fiber poly(p-phenylene-3,4′-oxydiphenylene terephthalamide) woven fabric C were used (CTE: −4.7 ppm/° C.).

(2) Polybenzoxazole Fabric

Layers of a 100 μm (poly-p-phenylene benzo-bis-oxazol) non-woven fabric D were used (CTE: −0.5 ppm/° C.).

(3) Liquid Crystal Polyester Fabric

Layers of a 100 μm liquid crystal polyester woven fabric E were used (fusion point: 301° C., CTE: −6.5 ppm/° C.).

### MANUFACTURE EXAMPLE 3

### Low CTE Organic Film Reinforcement Material

(1) Aromatic Polyamide Film

Layers of a 50 μm film F were used, with a plasma treatment applied to the surfaces (CTE: −4.5 ppm/° C.).

(2) Polybenzoxazole Film

Layers of a 50 μm (poly-p-phenylene benzo-bis-oxazol) film G were used (CTE: −6.0 ppm/° C.).

(3) Liquid Crystal Polyester Film

Layers of a 50 μm liquid crystal polyester film H were used (fusion point: 306° C., CTE: −2.3 ppm/° C.).

### MANUFACTURE EXAMPLE 4

### Metal Layers for Forming Circuits

(1) Layers of a 20 μm Fe—Ni based alloy I were used (invar; CTE: 0.4 ppm/° C.). A plasma treatment was applied to the surfaces, which will be referred to as metal layers I-1.

(2) Rolled copper foils of a 2 μm thickness were attached to both sides of a 20 μm invar layer, to obtain a laminate J (CTE: 5.7 ppm/° C.). A black oxide treatment was applied to the surfaces of these laminates, which will be referred to as metal layers J-1.

(3) Layers of an 18 μm electro-deposited copper foil K were used (CTE: 17 ppm/° C.).

### MANUFACTURE EXAMPLE 5

### Resin Composition for Forming Solder Resists

(1) Layers of a 25 μm liquid crystal polyester resin sheet L were used (CTE: −5.0 ppm/° C.).

(2) Layers of product PSR4000AUS308 from Taiyo Ink Mfg. Co. were used as resin M (CTE: 59 ppm/° C.).

(3) Layers of a 30 μm epoxy resin sheet N, provided as product APL-3601A from Sumitomo Bakelite Co., Ltd., were used (CTE: 27 ppm/° C.).

### EXAMPLE 1

For the organic fiber reinforcement material C, the liquid crystal polyester films B were arranged on both sides, after which 50 μm fluorine resin films were placed on the outer sides, and 2 mm stainless steel plates were placed on the outer sides. The configuration was stacked at 293° C., with a pressure of 15 kgf/cm², for 30 minutes in a 5 mmHg vacuum, to produce double-sided metal clad laminates O-\textcircled{1}, \textcircled{2}, \textcircled{3}. To these metal clad laminates, through-holes of a 50 μm diameter were formed using UV-YAG laser, and after applying a desmearing treatment, copper plating was filled in the holes, while at the same time depositing copper over the surfaces. The plated copper on the surfaces was etched until the thickness of the metal layers was 25 μm, and circuits were formed in the surfaces, to provide double-sided printed circuit boards O-\textcircled{4}, O-\textcircled{5}, and O-\textcircled{6}. Evaluation results for these double-sided printed circuit boards are listed below in Table 1-1.

### EXAMPLE 2

Except that the organic fiber reinforcement material D was used, the same method as in Example 1 was used to produce D-\textcircled{1}. After delaminating and removing the fluorine resin films, the metal layers I-1 were selected and positioned on both outer sides according to Table 1-2, and the configuration was stacked and molded in the same manner as described above to produce a double-sided metal clad laminate D-\textcircled{2}. Solder resists were selected and placed such that the thickness above the metal circuits was about 15 μm. These were used to provide a double-sided printed circuit board D-\textcircled{3}. Evaluation results for this double-sided printed circuit board are listed below in Table 1-2.

### EXAMPLE 3

Except that the organic fiber reinforcement material E was used, the same method as in Example 1 was used to produce E-\textcircled{1}. After delaminating and removing the fluorine resin films, the metal layers J-1 were selected and positioned on both outer sides according to Table 1-2, and the configuration was stacked and molded in the same manner as described above to produce a double-sided metal clad laminate E-\textcircled{2}. Solder resists were selected and placed such that the thickness above the metal circuits was about 15 μm. These were used to provide a double-sided printed circuit board E-\textcircled{3}. Evaluation results for this double-sided printed circuit board are listed below in Table 1-2.

### EXAMPLE 4

Except that the organic fiber reinforcement material F was used, the same method as in Example 1 was used to produce F-\textcircled{1}. After delaminating and removing the fluorine resin films, the metal layers K were selected and positioned on both outer sides according to Table 1-2, and the configuration was stacked and molded in the same manner as described above to produce a double-sided metal clad laminate F-\textcircled{2}. Solder resists were selected and placed such that the thickness above the metal circuits was about 15 μm. These were used to provide a double-sided printed circuit board F-\textcircled{3}. Evaluation results for this double-sided printed circuit board are listed below in Table 1-2.

### EXAMPLE 5

Except that the organic fiber reinforcement material G was used, the same method as in Example 1 was used to produce G-\textcircled{1}. After delaminating and removing the fluorine resin films, the metal layers K were selected and positioned on both outer sides according to Table 1-2, and the configuration was stacked and molded in the same manner as described above to produce a double-sided metal clad laminate G-\textcircled{2}. Solder resists were selected and placed such that the thickness above the metal circuits was about 15 μm. These were used to provide a double-sided printed circuit board G-\textcircled{3}. Evaluation results for this double-sided printed circuit board are listed below in Table 1-2.

### EXAMPLE 6

Except that the organic fiber reinforcement material H was used, the same method as in Example 1 was used to produce H-\textcircled{1}. After delaminating and removing the fluorine resin films, the metal layers K were selected and positioned on both outer sides according to Table 1-2, and the configuration was stacked and molded in the same manner as described above to produce a double-sided metal clad laminate H-\textcircled{2}. Solder resists were selected and placed such that the thickness above the metal circuits was about 15 μm. These were used to provide a double-sided printed circuit board H-\textcircled{3}. Evaluation results for this double-sided printed circuit board are listed below in Table 1-2.

### EXAMPLE 7

To prepare build-up organic sheets, 25 μm layers of liquid crystal polyester film B-1 were arranged on both sides of a 50 μm woven fabric C-1, and 50 μm fluorine resin films were placed on the outer sides. The configuration was stacked as described above to produce a build-up organic sheet CB-\textcircled{1}. Also, the printed circuit boards of Example 1, produced using the organic fabric reinforcement materials and double-sided copper clad laminates of Example 1, were prepared as inner cores. A black oxide treatment was applied to these inner cores, and the build-up organic sheets CB-\textcircled{1} were used on both sides, according to Table 2-1, and metal layers were arranged in the outermost layers. The configurations were stacked and molded in the same manner to produce four-layer metal clad laminates. Here, blind via holes of a 50 μm diameter were formed using UV-YAG laser, and after applying a plasma desmearing treatment, copper plating was filled in the holes. The copper plating portions on the outer layers were etched until the thickness of the metal layers was 25 μm, and circuits were formed in the surfaces. A black oxide treatment was applied, after which the build-up organic sheets and metal layers were placed on both sides, and the procedures for stacking, processing blind via holes, desmearing, filling with copper plating, etching the outer layers, and forming circuits were repeated, to produce six-layer printed circuit boards. Resin compositions were coated or stacked over both sides as solder resists, and a conventional method such as alkaline development, etc., was applied. Other portions were uncovered using UV-YAG laser and plasma etching was applied to provide printed circuit boards. Evaluation results for these printed circuit boards are listed below in Table 2-1.

### EXAMPLE 8

To prepare build-up organic sheets, 25 μm layers of liquid crystal polyester film B-1 were arranged on both sides of a 50 μm non-woven fabric D-1, and 50 μm fluorine resin films were placed on the outer sides. The configuration was stacked as described above to produce a build-up organic sheet DB-\textcircled{1}. Also, the printed circuit board of Example 2, produced using the organic fabric reinforcement material and double-sided copper clad laminate of Example 2, was prepared as an inner core. A black oxide treatment was applied to this inner core, and the build-up organic sheets DB-\textcircled{1} were used on both sides, according to Table 2-2, and metal layers were arranged in the outermost layers. The configuration was stacked and molded in the same manner to produce a four-layer metal clad laminate. Here, blind via holes of a 50 μm diameter were formed using UV-YAG laser, and after applying a plasma desmearing treatment, copper plating was filled in the holes. The copper plating portions on the outer layers were etched until the thickness of the metal layers was 25 μm, and circuits were formed in the surfaces. A black oxide treatment was applied, after which the build-up organic sheets and metal layers were placed on both sides, and the procedures for stacking, processing blind via holes, desmearing, filling with copper plating, etching the outer layers, and forming circuits were repeated, to produce a six-layer printed circuit board. Resin compositions were coated or stacked over both sides as solder resists, and a conventional method such as alkaline development, etc., was applied. Other portions were uncovered using UV-YAG laser and plasma etching was applied to provide a printed circuit board. Evaluation results for this printed circuit board are listed below in Table 2-2.

### EXAMPLE 9

To prepare build-up organic sheets, 25 μm layers of liquid crystal polyester film B-1 were arranged on both sides of a 50 μm non-woven fabric E-1, and 50 μm fluorine resin films were placed on the outer sides. The configuration was stacked as described above to produce a build-up organic sheet EB-\textcircled{1}. Also, the printed circuit board of Example 3, produced using the organic fabric reinforcement material and double-sided copper clad laminate of Example 3, was prepared as an inner core. A black oxide treatment was applied to this inner core, and the build-up organic sheets EB-\textcircled{1} were used on both sides, according to Table 2-2, and metal layers were arranged in the outermost layers. The configuration was stacked and molded in the same manner to produce a four-layer metal clad laminate. Here, blind via holes of a 50 μm diameter were formed using UV-YAG laser, and after applying a plasma desmearing treatment, copper plating was filled in the holes. The copper plating portions on the outer layers were etched until the thickness of the metal layers was 25 μm, and circuits were formed in the surfaces. A black oxide treatment was applied, after which the build-up organic sheets and metal layers were placed on both sides, and the procedures for stacking, processing blind via holes, desmearing, filling with copper plating, etching the outer layers, and forming circuits were repeated, to produce a six-layer printed circuit board. Resin compositions were coated or stacked over both sides as solder resists, and a conventional method such as alkaline development, etc., was applied. Other portions were uncovered using UV-YAG laser and plasma etching was applied to provide a printed circuit board. Evaluation results for this printed circuit board are listed below in Table 2-2.

### EXAMPLE 10

To prepare build-up organic sheets, 25 μm layers of liquid crystal polyester film B-1 were arranged on both sides of a 50 μm non-woven fabric F-1, and 50 μm fluorine resin films were placed on the outer sides. The configuration was stacked as described above to produce a build-up organic sheet FB-\textcircled{1}.

Also, the printed circuit board of Example 4, produced using the organic fabric reinforcement material and double-sided copper clad laminate of Example 4, was prepared as an inner core. A black oxide treatment was applied to this inner core, and the build-up organic sheets FB-\textcircled{1} were used on both sides, according to Table 2-2, and metal layers were arranged in the outermost layers. The configuration was stacked and molded in the same manner to produce a four-layer metal clad laminate. Here, blind via holes of a 50 μm diameter were formed using UV-YAG laser, and after applying a plasma desmearing treatment, copper plating was filled in the holes. The copper plating portions on the outer layers were etched until the thickness of the metal layers was 25 μm, and circuits were formed in the surfaces. A black oxide treatment was applied, after which the build-up organic sheets and metal layers were placed on both sides, and the procedures for stacking, processing blind via holes, desmearing, filling with copper plating, etching the outer layers, and forming circuits were repeated, to produce a six-layer printed circuit board. Resin compositions were coated or stacked over both sides as solder resists, and a conventional method such as alkaline development, etc., was applied. Other portions were uncovered using UV-YAG laser and plasma etching was applied to provide a printed circuit board. Evaluation results for this printed circuit board are listed below in Table 2-2.

### EXAMPLE 11

To prepare build-up organic sheets, 25 μm layers of liquid crystal polyester film B-1 were arranged on both sides of a 50 μm non-woven fabric G-1, and 50 μm fluorine resin films were placed on the outer sides. The configuration was stacked as described above to produce a build-up organic sheet GB-\textcircled{1}.

Also, the printed circuit board of Example 5, produced using the organic fabric reinforcement material and double-sided copper clad laminate of Example 5, was prepared as an inner core. A black oxide treatment was applied to this inner core, and the build-up organic sheets GB-\textcircled{1} were used on both sides, according to Table 2-2, and metal layers were arranged in the outermost layers. The configuration was stacked and molded in the same manner to produce a four-layer metal clad laminate. Here, blind via holes of a 50 μm diameter were formed using UV-YAG laser, and after applying a plasma desmearing treatment, copper plating was filled in the holes. The copper plating portions on the outer layers were etched until the thickness of the metal layers was 25 μm, and circuits were formed in the surfaces. A black oxide treatment was applied, after which the build-up organic sheets and metal layers were placed on both sides, and the procedures for stacking, processing blind via holes, desmearing, filling with copper plating, etching the outer layers, and forming circuits were repeated, to produce a six-layer printed circuit board. Resin compositions were coated or stacked over both sides as solder resists, and a conventional method such as alkaline development, etc., was applied. Other portions were uncovered using UV-YAG laser and plasma etching was applied to provide a printed circuit board. Evaluation results for this printed circuit board are listed below in Table 2-2.

### EXAMPLE 12

To prepare build-up organic sheets, 25 μm layers of liquid crystal polyester film B-1 were arranged on both sides of a 50 μm non-woven fabric H-1, and 50 μm fluorine resin films were placed on the outer sides. The configuration was stacked as described above to produce a build-up organic sheet HB-\textcircled{1}.

Also, the printed circuit board of Example 6, produced using the organic fabric reinforcement material and double-sided copper clad laminate of Example 6, was prepared as an inner core. A black oxide treatment was applied to this inner core, and the build-up organic sheets HB-\textcircled{1} were used on both sides, according to Table 2-2, and metal layers were arranged in the outermost layers. The configuration was stacked and molded in the same manner to produce a four-layer metal clad laminate. Here, blind via holes of a 50 μm diameter were formed using UV-YAG laser, and after applying a plasma desmearing treatment, copper plating was filled in the holes. The copper plating portions on the outer layers were etched until the thickness of the metal layers was 25 μm, and circuits were formed in the surfaces. A black oxide treatment was applied, after which the build-up organic sheets and metal layers were placed on both sides, and the procedures for stacking, processing blind via holes, desmearing, filling with copper plating, etching the outer layers, and forming circuits were repeated, to produce a six-layer printed circuit board. Resin compositions were coated or stacked over both sides as solder resists, and a conventional method such as alkaline development, etc., was applied. Other portions were uncovered using UV-YAG laser and plasma etching was applied to provide a printed circuit board. Evaluation results for this printed circuit board are listed below in Table 2-2.

### COMPARATIVE EXAMPLE 1

A double-sided copper clad laminate (product code: CCL-HL830, Mitsubishi Gas Chemical Company, Inc.) was used that includes a 150 μm E-glass woven fabric as the reinforcement material, and 150 μm insulation layers of bismaleimide•cyanate ester resin and epoxy resin, and 18 μm electro-deposited copper foils as metal layers on both sides. The procedures for forming through-holes, desmearing, copper plating, and forming circuits were performed in the same manner, to produce a double-sided printed circuit board P-\textcircled{2}. A conventional alkaline development type UV solder resist M was used, by a method known to those skilled in the art, to produce a double-sided printed circuit board P-\textcircled{3}. Also, a black oxide treatment was applied to the inner core printed circuit board, and one layer of a 60 μm build-up prepreg (product code: GHPL-830 MBH, Mitsubishi Gas Chemical Company, Inc.) was placed on either side, and 18 μm electro-deposited copper foils were arranged on the outer sides. The configuration was stacked at 190° C., with a pressure of 20 kgf/cm², for 90 minutes in a 5 mmHg vacuum, to produce a four-layer double-sided copper clad laminate. The procedures were repeated in the same manner to produce a six-layer printed circuit board P-\textcircled{4}. A conventional alkaline development type UV solder resist M was used for the solder resists. Evaluation results are listed below in Table 1-3 and Table 2-3.

### COMPARATIVE EXAMPLE 2

For a 150 μm aromatic polyamide non-woven fabric used as the reinforcement material, epoxy resin was attached, to produce an organic sheet Q-\textcircled{1}. Using 18 μm electro-deposited copper foils as the metal layers, the configuration was stacked and molded at 175° C., with a pressure of 25 kgf/cm², for 60 minutes in a 5 mmHg vacuum, to produce a double-sided copper clad laminate Q-\textcircled{2}. This was used, in the same manner as described above, to produce a double-sided printed circuit board Q-\textcircled{3}. Also, epoxy resin was attached to a 50 μm aromatic polyamide non-woven fabric to produce a 60 μm organic sheet QX-\textcircled{1}. Layers of this organic sheet QX-\textcircled{1} were used to produce a six-layer printed circuit board Q-\textcircled{4}. A conventional alkaline development type UV solder resist M was used for the solder resists. Evaluation results are listed below in Table 1-3 and Table 2-3.

### COMPARATIVE EXAMPLE 3

For a 100 μm E-glass woven fabric used as the reinforcement material, layers of a 50 μm liquid crystal polyester resin film (product code: BIAC, fusion point 335° C., CTE: 17.1 ppm/° C., Gore-Tex Japan) were arranged on both sides, after which 50 μm fluorine resin films were placed on the outer sides, and 2 mm stainless steel plates were placed on the outer sides. The configuration was stacked and molded at 330° C., with a pressure of 25 kgf/cm², for 30 minutes in a 5 mmHg vacuum, to produce a prepreg R-\textcircled{1}. On both sides of this prepreg, 18 μm copper foils were arranged, and the configuration was stacked and molded in the same manner to produce a double-sided copper clad laminate R-\textcircled{2}. This was used, in the same manner as described above, to produce a double-sided printed circuit board R-\textcircled{3}. Also, for a 40 μm E-glass woven fabric, 25 μm layers of the liquid crystal polyester resin film were arranged on both sides, and the configuration was stacked in the same manner to produce a build-up sheet RY-\textcircled{1}. Layers of this sheet were used to produce a multi-layer printed circuit board R-\textcircled{4}. A conventional alkaline development type UV solder resist M was used for the solder resists. Evaluation results are listed below in Table 1-3 and Table 2-3.

TABLE 1-1

| | Example 1-1 | Example 1-2 | Example 1-3 |
|---|---|---|---|
| Reinforcement Material | C | C | C |
| Circuit Metal | I-1 | J-1 | K |
| Solder Resist | N | L | L |
| Double-Sided Printed | O-\textcircled{4} | O-\textcircled{5} | o-\textcircled{6} |
| Circuit Board | | | |
| Coefficient of Thermal | 5.3 | −2.0 | −0.6 |
| Expansion of Double- | | | |
| Sided Printed Circuit | | | |
| Board (ppm/° C.) | | | |
| Bending/Warpage | 21 | 58 | 33 |
| after Mounting | | | |
| Semiconductor Chip (μm) | | | |
| Faultless Products after | 100/100 | 100/100 | 100/100 |
| Thermal Shock Test | | | |
| (n/100) | | | |

TABLE 1-2

| | Exam- | Exam- | Exam- | Exam- | Exam- |
|---|---|---|---|---|---|
| | ple 2 | ple 3 | ple 4 | ple 5 | ple 6 |
| Reinforcement Material | D | E | F | G | H |
| Organic Sheet | D-\textcircled{1} | E-\textcircled{1} | F-\textcircled{1} | G-\textcircled{1} | H-\textcircled{1} |
| Circuit Metal | I-1 | J-1 | K | I-1 | J-1 |
| Solder Resist | N | N | L | N | N |
| Double-Sided Printed | D-\textcircled{3} | E-\textcircled{3} | F-\textcircled{3} | G-\textcircled{3} | H-\textcircled{3} |
| Circuit Board | | | | | |
| Coefficient of Thermal | 5.0 | 3.2 | −1.2 | 3.5 | 5.1 |
| Expansion of Double- | | | | | |
| Sided Printed Circuit | | | | | |
| Board (ppm/° C.) | | | | | |
| Bending/Warpage after | 47 | 20 | 62 | 28 | 47 |
| Mounting Semiconductor | | | | | |
| Chip (μm) | | | | | |
| Faultless Products after | 100/100 | 100/100 | 100/100 | 100/100 | 100/100 |
| Thermal Shock Test | | | | | |
| (n/100) | | | | | |

TABLE 1-3

| | Comparative Ex. 1-1 | Comparative Ex. 2-1 | Comparative Ex. 3-1 |
|---|---|---|---|
| Reinforcement Material | E-glass Woven Fabric | Aromatic Polyamide | E-glass Woven Fabric |
| | 150 μm | Non-Woven Fabric | 100 μm |
| | | 150 μm | |
| Build-Up Sheet | known PPG | Q-\textcircled{1} | R-\textcircled{1} |
| Circuit Metal | K | K | K |
| Solder Resist | M | M | M |
| Double-Sided Printed | P-\textcircled{3} | Q-\textcircled{3} | R-\textcircled{3} |
| Circuit Board | | | |
| Coefficient of Thermal | 23.9 | 15.1 | 21.2 |
| Expansion of Double- | | | |
| Sided Printed Circuit | | | |
| Board (ppm/° C.) | | | |
| Bending/Warpage | 693 | 459 | 680 |
| after Mounting | | | |
| Semiconductor Chip (μm) | | | |
| Faultless Products after | 0/100 | 23/100 | 1/100 |
| Thermal Shock Test | | | |
| (n/100) | | | |

TABLE 2-1

| | Example 7-1 | Example 7-2 | Example 7-3 |
|---|---|---|---|
| Build-Up Organic Sheet | CB-\textcircled{1} | CB-\textcircled{1} | CB-\textcircled{1} |
| Circuit Metal | I-1 | J-1 | K |
| Solder Resist | M | M | M |
| Six-Layer Printed Circuit | O-\textcircled{6} | O-\textcircled{7} | O-\textcircled{8} |
| Board | | | |
| Coefficient of Thermal | 3.9 | 4.2 | 5.5 |
| Expansion of Six-Layer | | | |
| Printed Circuit Board | | | |
| (ppm/° C.) | | | |
| Bending/Warpage | 26 | 34 | 58 |
| after Mounting | | | |
| Semiconductor Chip (μm) | | | |
| Faultless Products after | 100/100 | 100/100 | 100/100 |
| Thermal Shock Test | | | |
| (n/100) | | | |

TABLE 2-2

| | Exam- | Exam- | Exam- | Exam- | Exam- |
|---|---|---|---|---|---|
| | ple 8 | ple 9 | ple 10 | ple 11 | ple 12 |
| Build-Up Organic Sheet | DB-\textcircled{1} | EB-\textcircled{1} | FB-\textcircled{1} | GB-\textcircled{1} | HB\textcircled{1} |
| Organic Sheet | I-1 | K | K | K | K |
| Circuit Metal | M | M | M | M | M |
| Solder Resist | D-\textcircled{4} | E-\textcircled{4} | F-\textcircled{4} | G-\textcircled{4} | H-\textcircled{4} |
| Six-Layer Printed Circuit | 3.9 | 4.0 | 4.9 | 4.6 | 5.4 |
| Board | | | | | |
| Coefficient of Thermal | 25 | 27 | 51 | 49 | 54 |
| Expansion of Six-Layer | | | | | |
| Printed Circuit Board | | | | | |
| (ppm/° C.) | | | | | |
| Bending/Warpage after | 100/100 | 100/100 | 100/100 | 100/100 | 100/100 |
| Mounting Semiconductor | | | | | |
| Chip (μm) | | | | | |
| Faultless Products after | 100/100 | 100/100 | 100/100 | 100/100 | 100/100 |
| Thermal Shock Test | | | | | |
| (n/100) | | | | | |

TABLE 2-3

| | Comparative | Comparative | Comparative |
|---|---|---|---|
| | Ex. 1-2 | Ex. 2-2 | Ex. 3-2 |
| Build-Up Sheet | known PPG | QX-\textcircled{1} | RY-\textcircled{1} |
| Circuit Metal | K | K | K |
| Solder Resist | M | M | M |
| Six-Layer Printed Circuit | P-\textcircled{4} | Q-\textcircled{4} | R-\textcircled{4} |
| Board | | | |
| Coefficient of Thermal | 19.5 | 13.0 | 15.7 |
| Expansion of Six-Layer | | | |
| Printed Circuit Board | | | |
| (ppm/° C.) | | | |
| Bending/Warpage | 510 | 138 | 477 |
| after Mounting | | | |
| Semiconductor Chip (μm) | | | |
| Faultless Products after | 7/100 | 33/100 | 17/100 |
| Thermal Shock Test (n/100) | | | |

### Measurement Method

(1) Coefficient of Thermal Expansion

Values were measured using TMA. The values were recorded for 25-150° C.

(2) Bending and Warpage

A semiconductor plastic package was produced by connecting one semiconductor chip with dimensions of 10×10 mm and a thickness of 300 μm on one side, in the center of a 40×40 mm printed circuit board, without using with an underfill resin. The bending and warpage were measured using a laser measurement apparatus for one hundred of such packages. The printed circuit boards were selected which initially displayed bending and warpage of 50±5 μm. The maximum values of bending and warpage were measured again using a laser measurement apparatus after mounting and connecting the semiconductor chip, and the maximum increase was recorded.

(3) Thermal Shock Test

One hundred semiconductor plastic packages produced as described above were subject to temperature cycle tests, in which the temperature was maintained at −60° C. for 30 minutes and then at 150° C. for 30 minutes for one cycle. After 1000 cycles, the integrity of the electrical connection was evaluated. A change in resistance value of ±15% or more was classified as a defect. The samples were also checked for cracking and delamination in the solder. The number of flawless products was recorded as the numerator.

As set forth above, a method for manufacturing an insulating sheet, as well as methods for manufacturing a metal clad laminate and a printed circuit board, according to certain embodiments of the invention can be utilized to produce an insulation board that has a coefficient of thermal expansion close to that of the semiconductor chip, and thereby prevent bending or warpage in the multi-layer printed circuit board using the insulation board. Furthermore, the stress in the material connecting the semiconductor chip with the printed circuit board can be reduced, so that cracking or delamination in the connecting material, such as lead-free solder, may be avoided.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing an insulating sheet, the method comprising:
stacking a thermoplastic resin layer over a reinforcement material; and
hot pressing the thermoplastic resin layer into the reinforcement material.

2. The method of claim 1, wherein the reinforcement material has a coefficient of thermal expansion within a range of −20 to 9 ppm/° C. in longitudinal and lateral directions.

3. The method of claim 1, wherein the reinforcement material includes organic fibers.

4. The method of claim 3, wherein the organic fibers are made of aromatic polyamide or polybenzoxazole.

5. The method of claim 1, wherein the thermoplastic resin layer has a coefficient of thermal expansion within a range of −20 to 9 ppm/° C. in longitudinal and lateral directions.

6. The method of claim 1, wherein the thermoplastic resin layer includes liquid crystal polyester resin.

7. The method of claim 1, wherein the reinforcement material has a higher fusion point than that of the thermoplastic resin layer.

8. The method of claim 1, wherein the hot pressing is performed with a pressure of 1 to 50 kgf/cm² at a temperature of 10 to 50° C. higher than a fusion point of the thermoplastic resin layer.

9. The method of claim 1, further comprising, before hot pressing the thermoplastic resin layer:
stacking a detachable sheet over the thermoplastic resin layer.

10. A method of manufacturing a metal clad laminate, the method comprising:
stacking a thermoplastic resin layer over a reinforcement material;
hot pressing the thermoplastic resin layer into the reinforcement material; and
forming a metal layer over the thermoplastic resin layer.

11. The method of claim 10, wherein the reinforcement material has a coefficient of thermal expansion within a range of −20 to 9 ppm/° C. in longitudinal and lateral directions.

12. The method of claim 10, wherein the reinforcement material includes organic fibers.

13. The method of claim 12, wherein the organic fibers are made of any one of aromatic polyamide and polybenzoxazole.

14. The method of claim 10, wherein the thermoplastic resin layer has a coefficient of thermal expansion in a range of −20 to 9 ppm/° C. in longitudinal and lateral directions.

15. The method of claim 10, wherein the thermoplastic resin layer includes liquid crystal polyester resin.

16. The method of claim 10, wherein the reinforcement material has a higher fusion point than that of the thermoplastic resin layer.

17. The method of claim 10, wherein the hot pressing is performed with a pressure of 1 to 50 kgf/cm² at a temperature of 10 to 50° C. higher than a fusion point of the thermoplastic resin layer.

18. A method of manufacturing a printed circuit board, the method comprising:
stacking a thermoplastic resin layer over a reinforcement material;
hot pressing the thermoplastic resin layer into the reinforcement material;
forming a metal layer over the thermoplastic resin layer; and
forming a circuit pattern by etching the metal layer.

19. The method of claim 18, wherein the reinforcement material has a coefficient of thermal expansion in a range of −20 to 9 ppm/° C. in longitudinal and lateral directions.

20. The method of claim 18, wherein the reinforcement material includes organic fibers.

21. The method of claim 20, wherein the organic fibers are made of aromatic polyamide or polybenzoxazole.

22. The method of claim 18, wherein the thermoplastic resin layer has a coefficient of thermal expansion in a range of −20 to 9 ppm/° C. in longitudinal and lateral directions.

23. The method of claim 18, wherein the thermoplastic resin layer includes liquid crystal polyester resin.

24. The method of claim 18, wherein the reinforcement material has a higher fusion point than that of the thermoplastic resin layer.

25. The method of claim 18, wherein the hot pressing is performed with a pressure of 1 to 50 kgf/cm² at a temperature of 10 to 50° C. higher than a fusion point of the thermoplastic resin layer.
